(19) United States
(12) Patent Application Publication
(10) Pub. No.: US 2023/0158836 A1
(43) Pub. Date: May 25, 2023

(54) PNEUMATIC VEHICLE TIRE OF RADIAL DESIGN FOR UTILITY VEHICLE TIRES

(71) Applicant: Continental Reifen Deutschland GmbH, Hannover (DE)

(72) Inventors: Tiago Moura, Hannover (DE); Florian Berger, Hannover (DE); Fabian Wachmann, Hannover (DE)

(73) Assignee: Continental Reifen Deutschland GmbH, Hannover (DE)

(21) Appl. No.: 17/995,307

(22) PCT Filed: Mar. 17, 2021
(86) PCT No.: PCT/DE2021/200035

§ 371 Date: Oct. 1, 2022

(30) Foreign Application Priority Data
Apr. 3, 2020 (DE) 10 2020 204 344.2

(51) Int. Cl. B60C 9/20; B60C 9/00; D07B 1/06

(52) U.S. Cl. CPC B60C 9/2006; B60C 9/20; B60C 9/0007; D07B 1/0613; B60C 2200/06; B60C 2009/2096; B60C 2009/2077; B60C 2009/2093; B60C 2009/0092; D07B 2501/2046; D07B 2201/1032; D07B 2205/3025; D07B 2201/2009; D07B 2401/2025

(57) ABSTRACT

A pneumatic vehicle tire of radial type of construction for utility vehicles, in particular trucks, buses and truck trailers, having a belt which has three or more belt plies (5, 6, 7, 8, 9) with steel cords (10), wherein each steel cord (10) has at least two strands (11) and wherein each strand (11) has at least two steel filaments (12); the invention is characterized in that steel cords (10) of the construction 2 to 4×N, where N=2 to 5, are at least arranged in one of the belt plies (5, 6, 7, 8, 9), wherein this construction means that this steel cord (10) has 2 to 4 twisted-together strands (11), wherein each strand (10) comprises 2 to 5 steel filaments (12) which are twisted together such that these 2 to 5 steel filaments (12) are arranged without a core filament.

The invention relates to a pneumatic vehicle tire of radial type of construction for utility vehicles, in particular trucks, buses and truck trailers, having a belt which has three or more belt plies with steel cords, wherein each steel cord has at least two strands and wherein each strand has at least two steel filaments.

Belt constructions of utility vehicle tires are well known to a person skilled in the art. Common belt constructions of utility vehicle tires commonly have four plies, which are composed of steel cords embedded in rubber compounds. In a 4-ply belt, the radially innermost ply is designated the “1st belt ply” or, depending on its function, the “barrier ply”. Arranged radially on the outside of the latter are the 2nd belt ply and the 3rd belt ply acting as what are known as “working plies”. The radially outer working ply is covered by the 4th belt ply, known as the “cover ply” or “protective ply”.

It is likewise known to provide a further belt ply known as a “0° ply”, the strength members of which run approximately in a circumferential direction of the tire (+/−5° in relation to the circumferential direction) and which is commonly arranged either between the working plies or radially within the working plies.

The steel cords of the 1st belt ply generally exhibit an angle of >45° with respect to the circumferential direction. The 1st belt ply, on account of its function of preventing the working plies from being able to move in the circumferential direction, is referred to as the “barrier ply”. The steel cords of the two working plies typically exhibit an identical angle of between 15° and 35° with respect to the tire circumferential direction, wherein the steel cords of one working ply are inclined in the opposite direction to the steel cords of the other working ply with respect to the tire circumferential direction. Thus, the steel cords of one working ply are arranged so as to cross the steel cords of the other working ply. The working plies are subjected to high shear and tensile forces, bear the main load in the belt and are therefore of particular significance for belt durability.

The 4th belt ply has the function of a protective ply for the two working plies located therebeneath, in that it represents a barrier for stones or other objects that could penetrate the tread assembly. The strength members commonly have an angle of between 15° and 25° in relation to the circumferential direction of the tire. Without the protective ply, the cords of the working plies would be damaged by frequently penetrating stones and be subject to increased corrosion, and this would ultimately considerably reduce the load capacity, the durability and the retread capacity of the tire.

Steel cords for reinforcement plies of vehicle tires are likewise well known to a person skilled in the art. A steel cord is generally distinguished by the fact that it has at least two steel filaments that are twisted together.

In the 0° ply, use has hitherto been made of steel cords for example of the construction 3×7×0.22 mm. In this construction, three strands with in each case 7 steel filaments of 0.22 mm diameter are twisted together to form a steel cord. The 7 steel filaments are arranged in each strand such that 6 ply filaments are twisted around 1 core filament.

Such a cord is particularly compact and stable and is nowadays used for example in a 0° ply or the protective ply of a utility vehicle tire. The filaments of a strand are arranged close together such that said strand is referred to as “closed” and, when the steel cords are embedded into the rubber compound, no rubber can penetrate between the filaments of the cord. For the utility vehicle tire in operation, in which the strength members in a 0° ply are arranged approximately in a circumferential direction, this compactness, and certain elongation that can be achieved only with great expenditure of force, is advantageous in order to maintain the tire contour against the centrifugal forces during driving operation. This is however a disadvantage in the tire building process, in which the green tire must be lifted into the vulcanizing mold and an elongation by approximately 2% is necessary for this purpose. Furthermore, the above-mentioned cord can be susceptible to corrosion, in particular if it is used in the protective ply, which is susceptible to cutting and damage. This is because the rubber does not penetrate into the strand, as a result of which a route for moisture is formed between the filaments. Furthermore, a strand with core and ply filaments tends to exhibit so-called fretting effects, which can reduce durability.

“Fretting effects” are scuffing effects which occur locally at contact points/areas of two adjacent filaments and/or of adjacent strands and which can adversely affect the durability of the strength member.

The invention therefore addresses the problem of designing a pneumatic vehicle tire of radial type of construction for utility vehicles, having a belt, of the type mentioned in the introduction such that said pneumatic vehicle tire can be lifted in an effective manner as a green tire into the vulcanizing mold during the tire building process, which pneumatic vehicle tire is improved in terms of its durability as a fully vulcanized tire.

Said object is achieved according to the invention in that this steel cord has the construction 2 to 4×N, where N=2 to 5, wherein this construction means that the steel cord has 2 to 4 twisted-together strands, wherein each strand comprises 2 to 5 steel filaments which are twisted together such that these 2 to 5 steel filaments are arranged without a core filament.

It is essential to the invention that each strand of this steel cord has 2 to 5 filaments, which are however twisted such that no core filament is present. In this way, a so-called open cord construction is created into which rubber can penetrate. This rubber that has penetrated between the filaments of the strand prevents transport of moisture within the strand, whereby corrosion is substantially prevented. The durability of the belt ply and thus of the pneumatic vehicle tire is improved. Furthermore, the open construction allows an elongation of the cord by the required approximately 2% for the lifting of the green tire during the tire building process. Thereafter, a desired high expenditure of force is required for the further elongation of the cord. Likewise, fretting effects are reduced owing to the rubber that has penetrated between the filaments, whereby the durability of the belt ply and thus of the pneumatic vehicle tire is likewise improved.

It is expedient if this steel cord has the construction 2 to 4×N, where N=3 or 4, particularly preferably the construction 3 to 4×N, where N=4. In this way, adequate breaking strength is achieved, with simultaneous rubber penetration between the filaments of the steel cord.

It is advantageous if the filament diameter of each filament is identical and lies between 0.20-0.40 mm, preferably between 0.25-0.30 mm, particularly preferably between 0.26-0.29 mm. In this way, adequate breaking strength is achieved, with simultaneous rubber penetration between the filaments of this steel cord.

It is advantageous if the elongation at 100 N of this non-rubberized steel cord is 1% to 4%, preferably 2% to 3%, wherein the above-stated elongation of this non-rubberized steel cord is ascertained in accordance with ASTM D 2969. It is hereby furthermore ensured that, in the heating process, the tire can be lifted in an ideal manner into the mold.

In one particular embodiment of the invention, this steel cord has the construction 3×4×0.29 mm, wherein the elongation at 100 N of this non-rubberized steel cord is preferably 2% to 3%, wherein the above-stated elongation of this non-rubberized steel cord is ascertained in accordance with ASTM D 2969.

In another particular embodiment of the invention, this steel cord has the construction 4×4×0.26 mm, wherein the elongation at 100 N of this non-rubberized steel cord is preferably 2% to 3%, wherein the above-stated elongation of this non-rubberized steel cord is ascertained in accordance with ASTM D 2969.

In one embodiment of the invention, the pneumatic vehicle tire of radial type of construction for utility vehicles has a four-ply belt with two working plies, one barrier ply and one 0° ply, wherein these steel cords of the above-described embodiments are arranged in the 0° ply.

In another embodiment of the invention, the pneumatic vehicle tire has at least four belt plies, of which at least two working plies and additionally one barrier ply and one protective ply and/or one 0° ply are provided, wherein these steel cords are arranged in the 0° ply and/or in the protective ply.

Further features, advantages and details of the invention will now be described in more detail on the basis of the schematic drawings, which illustrate exemplary embodiments. In the drawings:

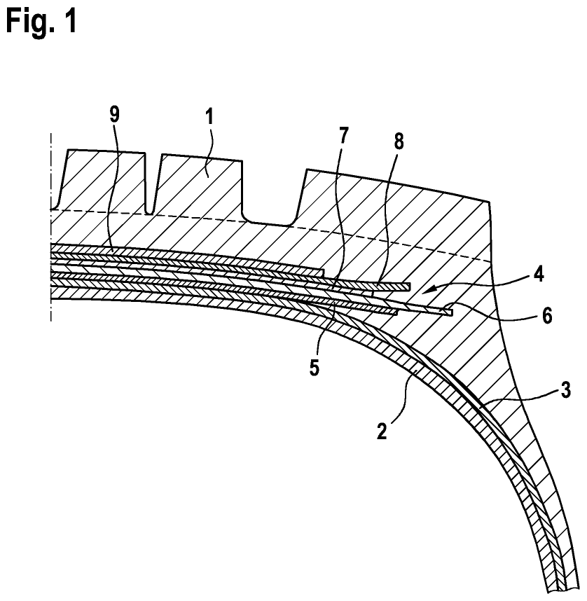

FIG. 1 shows a partial cross section through a pneumatic vehicle tire according to the invention for utility vehicles in the region of the belt and tread;

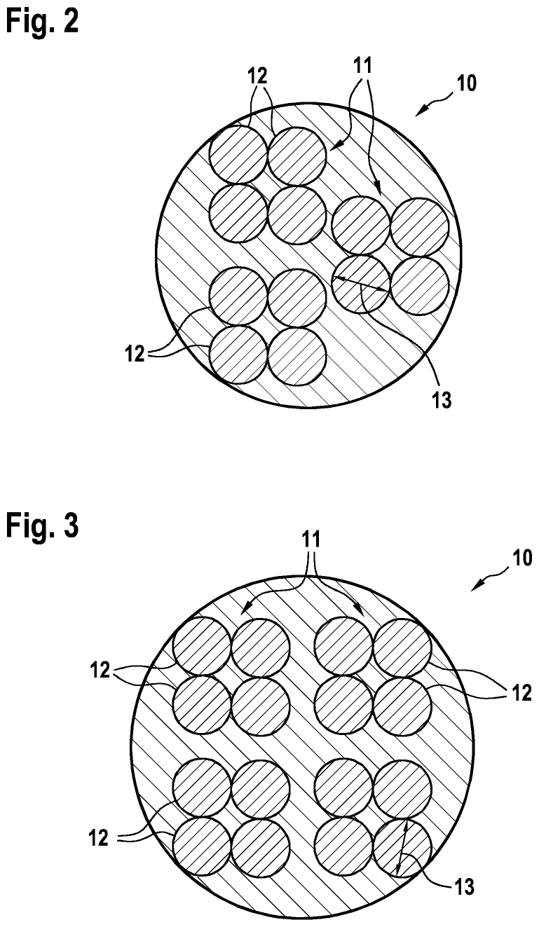

FIG. 2 shows a cross section through a steel cord that is arranged in the protective ply and/or in the 0° ply of the pneumatic vehicle tire of FIG. 1;

FIG. 3 shows a cross section through another steel cord that is arranged in the protective ply and/or in the 0° ply of the pneumatic vehicle tire of FIG. 1.

FIG. 1 shows a cross section through the region of the tread and belt of a pneumatic vehicle tire according to the invention for utility vehicles, for example trucks, buses or truck trailers. Of the components that are commonly present in the illustrated region of the pneumatic vehicle tire, a profiled tread 1, an inner layer 2, a carcass insert 3 and a multi-ply belt 4 are shown. Belt padding and the like that is commonly provided between the edge portions of the belt plies, in particular in the region of the belt ply edges, is not shown.

The belt 4 has five belt plies 5, 6, 7, 8 and 9, wherein the first belt ply is the radially innermost belt ply 5 and is configured as a barrier ply. The second belt ply 6 is a working ply, which is followed by a 0° ply 7, above which the third belt ply 8 is arranged as a working ply. The third belt ply 8 is adjoined by the radially outermost belt ply 9, the protective ply. All belt plies 5, 6, 7, 8 and 9 are composed of strength members embedded in a rubber compound, the so-called belt rubber coating, which strength members run parallel to one another in each ply.

The strength members in the belt plies 5, 6, 7, 8 and 9 are inclined at particular angles relative to the circumferential direction. Proceeding from the radially innermost belt ply 5, the strength members run in accordance with the sequence right-hand pitch-right-hand pitch-0°-left-hand pitch-left-hand pitch. A 0° belt ply 7 is to be understood to mean a belt ply in which the strength members run in a circumferential direction, and deviate by at most ±5° from the exact 0° orientation. The angle of the strength members in the first belt ply 5 is 45° to 90°, in particular 48° to 57°, the angle of the strength members in the 0° belt ply 7 is 0°±5°, the angles of the strength members in the second and third belt plies (working plies) 6, 8 are in each case 10° to 45°, and the angle of the strength members in the fourth belt ply 9 is likewise 10° to 45°, in each case in relation to the circumferential direction. As already mentioned, the second belt ply 6 and the third belt ply 8 are working plies, and the strength members thereof therefore run at relatively small angles with respect to the circumferential direction, and the plies have oppositely directed pitches.

Here, the steel cord 10 of FIG. 2 is arranged in the 0° belt ply 7 and/or in the radially outermost belt ply, the protective ply 9, of the utility vehicle tire of FIG. 1. The construction conforms to 3×4×0.29 mm, which means that three strands 11 with in each case 4 steel filaments 12 with a diameter 13 of in each case 0.29 mm are twisted to form a steel cord 10. The elongation at 100 N of the non-rubberized cord is 1% to 4%, wherein the above-stated elongation of the non-rubberized cord is ascertained in accordance with ASTM D 2969.

Another steel cord 10 is shown in FIG. 3. This is likewise arranged in the 0° belt ply 7 and/or in the radially outermost belt ply, the protective ply 9, of the utility vehicle tire of FIG. 1. The construction conforms to 4×4×0.26 mm, which means that four strands 11 with in each case 4 steel filaments 12 with a diameter 13 of in each case 0.26 mm are twisted to form a steel cord 10.

### LIST OF REFERENCE DESIGNATIONS

1 . . . Tread
2 . . . Inner layer
3 . . . Carcass insert
4 . . . Belt
5 . . . First belt ply/barrier ply
6 . . . Second belt ply/working ply
7 . . . 0° belt ply
8 . . . Third belt ply/working ply
9 . . . Fourth belt ply/protective ply
10 . . . Steel cord
11 . . . Strand
12 . . . Steel filament
13 . . . Diameter of the steel filament

1-8. (canceled)

9. A pneumatic vehicle tire of radial type of construction, the tire comprising:
a belt having three or more belt plies (4) with steel cords (10), each steel cord (10) has at least two strands (11) and wherein each strand (11) has at least two steel filaments (12);
the steel cords (10) are of the construction 2 to 4×N, where N=2 to 5, are arranged in the belt plies (4);
the steel cords (10) have 2 to 4 twisted-together strands (11); and
each strand (10) comprises 2 to 5 steel filaments (12) twisted together and arranged without a core filament.

10. The pneumatic vehicle tire as claimed in claim 9, the steel cords (10) have the construction N=4.

11. The pneumatic vehicle tire as claimed in claim 10, a filament diameter (13) of each steel filament (12) is identical and between 0.26-0.29 mm.

12. The pneumatic vehicle tire of claim 11, the elongation at 100 N of this non-rubberized steel cord is 2% to 3%, the above-stated elongation of this non-rubberized steel cord is ascertained in accordance with ASTM D 2969.

13. The pneumatic vehicle tire of claim 12, the steel cords (10) have the construction 3×4×0.29.

14. The pneumatic vehicle tire of claim 9, the steel cords (10) have the construction 4×4×0.26 mm, the elongation at 100 N of this non-rubberized steel cord is 2% to 3%, the above-stated elongation of the non-rubberized steel cord is ascertained in accordance with ASTM D 2969.

15. The pneumatic vehicle tire of claim 14, the three or more plies comprise a four-ply belt (5, 6, 7, 8) with two working plies, one barrier ply and one 0° ply, the steel cords are arranged in the 0° ply.

16. The pneumatic vehicle tire of claim 9, the three or more plies comprise five belt plies (5, 6, 7, 8, 9) that comprise two working plies (6, 8), one barrier ply (5), one protective ply (9), and one 0° ply (7), and the steel cords (10) are arranged in the 0° ply (7).

17. The pneumatic vehicle tire of claim 9, the tire incorporated into one of a utility vehicle, truck, bus, and truck trailer.

18. The pneumatic vehicle tire of claim 15, the tire comprising a carcass insert (3) adjacent and radially inner of the barrier ply (5) and an inner layer (2) radially inner of the carcass insert (3).

19. The pneumatic vehicle tire of claim 18, the tire comprising a tread (1) radially outer from the protective ply (9).

20. The pneumatic vehicle tire of claim 19, the steel cords (10) for each ply of the four-ply belt are inclined at particular angles relative to the circumferential direction.

21. The pneumatic vehicle tire of claim 20, a steel cord of the barrier ply has a right-hand pitch, a steel cord of the two working plies have a right hand pitch, a steel cord of the one 0° ply is at 0 degrees.

22. The pneumatic vehicle tire of claim 16, the five belt plies are arranged with a first working ply (6) radially on the barrier ply (5), the one 0° ply (7) is radially on the first working ply (6), a second working ply (8) is on the one 0° ply (7) and the protective ply (9) is on the second working ply (8).

23. The pneumatic vehicle tire of claim 22, strength members of the barrier ply are at 48 to 57 degrees, strength members of the one 0° ply are at −5 to 5, strength members of first working ply (6) are at 10 to 45 degrees, strength members of the second working ply are at 10 to 45 degrees, strength members of the protective ply are at 10 to 45 degrees in relation to the circumferential direction.
